(19) United States
(12) Patent Application Publication
(10) Pub. No.: US 2022/0047991 A1
(43) Pub. Date: Feb. 17, 2022

(54) STORAGE PROTECTION FOR FORWARD OSMOSIS HYDRATION OR DEWATERING SYSTEM

(71) Applicant: Fluid Technology Solutions (FTS), Inc., Albany, OR (US)

(72) Inventors: Keith A. Lampi, Albany, OR (US); John R. Herron, Corvallis, OR (US); George Elmer Monigold, Albany, OR (US); Brian H. Silver, Albany, OR (US)

(21) Appl. No.: 17/444,791

(22) Filed: Aug. 10, 2021

Related U.S. Application Data
(60) Provisional application No. 63/064,674, filed on Aug. 12, 2020.

(51) Int. Cl. B01D 61/00; B01D 63/08; A23F 3/18

(52) U.S. Cl. CPC B01D 61/002; B01D 63/08; A23F 3/18; B01D 2313/08; B01D 2315/06; B01D 2313/23; B01D 2313/58; B01D 2313/90; B01D 2313/20

(57) ABSTRACT

The embodiments disclosed herein include forward osmosis hydration and dewatering devices. The forwards osmosis devices disclosed herein include one or more forward osmosis membranes and one or more barriers. The barriers are configured to protect the forward osmosis membranes from damage, such as damage caused by contact between at least one osmotic agent or another ingredients of the forward osmosis device.

### BACKGROUND OF THE DISCLOSURE

Forward osmosis membrane hydration pouches provide potable or even sterile water from salty, non-potable, or contaminated water. The hydration pouches typically have an interior space sealed with one or two forward osmosis membrane walls and contain an osmotic agent in the interior space. Other contents, such as flavoring or partially dehydrated food, can also be included in the interior space depending on the application. Forward osmosis membrane pouches containing osmotic agent can also be used in reverse, that is to remove water, for example by placing the pouch in a container with wine or juice or milk or other drink, resulting in water being transferred from the drink to the inside of the pouch thereby concentrating the drink.

### SUMMARY

Embodiments disclosed herein include forward osmosis hydration and dewatering devices. In an embodiment, a storage protection device for a forward osmosis hydration or dewatering system is disclosed. The storage protection device includes one or more forward osmosis membranes at least partially defining an interior. The storage protection device also includes one or more barriers including one or more osmotic agents disposed therein. The one or more barriers are disposed in the interior. The one or more barriers are configured to prior to introducing a challenge liquid to the interior, separate the at least one osmotic agent and the one or more forward osmosis membranes and, after introducing the challenge liquid to the interior, allow the challenge liquid to access the at least one osmotic agent disposed in the chamber.

In an embodiment, an ingredient separation device within a forward osmosis system is disclosed. The ingredient separation device includes one or more forward osmosis membranes at least partially defining an interior. The interior is configured to be in direct fluid contact with the one or more forward osmosis membranes during post manufacturing, transportation, and storage period. The interior contains two or more ingredients including at least one osmotic agent. The ingredient separation device includes one or more barriers including some of the two or more ingredients disposed therein. The one or more barriers are configured to maintain the some of the two or more ingredients separate from a remainder of the two or more ingredients. The one or more barriers are disposed in the interior.

In an embodiment, a liquid flow management device for a forward osmosis system is disclosed. The liquid flow management device includes at least one osmotic agent and one or more barriers including the at least one osmotic agent therein. The one or more barriers are positioned in a structure that allows at least a portion of a challenge liquid to directly contact the one or more barriers causing at least a portion of the at least one osmotic agent to be released from the one or more barriers. Said structure has openings configured to encourage the at least a portion of the challenge liquid to flow in a manner as to promote mixing of contents within the forward osmosis system.

### BRIEF DESCRIPTION OF DRAWINGS

FIG. 1 isometric and cross-section view of a forward osmosis device, according to an embodiment.

FIG. 2 is an isometric cutaway view of two forward osmosis devices, according to an embodiment.

FIG. 3 is an isometric cutaway view of a forward osmosis device, according to an embodiment.

FIG. 4 is an isometric cutaway view of a dissolvable pouch that may be at least a portion of the barriers used in any of the forward osmosis devices disclosed herein, according to an embodiment.

FIG. 5 is an isometric view of a dissolvable strip or sheet, according to an embodiment.

FIG. 6 is an isometric cross-sectional view of a forward osmosis device, according to an embodiment.

### DETAILED DESCRIPTION

Embodiments disclosed herein include forward osmosis hydration and dewatering devices. Examples of the forward osmosis hydration and dewatering devices includes a storage protection device, an ingredient separation device, and a liquid flow management device. The forwards osmosis hydration and dewatering devices disclosed herein include one or more forward osmosis membranes that are protected from damage, such as damage caused by contact between at least one osmotic agent included in the forward osmosis device or any of the other product ingredients during storage of the forward osmosis device. The forward osmosis membranes may be configured as pouch though the forward osmosis membranes may be exhibit other configurations that may benefit from similar protection of the filter material (e.g., a spiral wound element). In an embodiment, the forward osmosis devices disclosed herein may not require any action on the part of a user of such devices to gain access to the osmotic agent or other product ingredients in the pouch prior to hydration. In other words, the forward osmosis devices disclosed herein may not require any action on the part of the user of such devices to use or otherwise obtain a benefit from the osmotic agent or other product ingredients other than hydrating the forward osmosis device. In an embodiment, the forward osmosis devices disclosed herein may require some action on the part of the user of such devices to gain access to the osmotic agent or other product ingredients prior to or after hydration.

The ingredients stored with the forward osmosis devices disclosed herein may include a salt (e.g., an oral rehydration salt, sodium chloride, calcium chloride, or potassium chloride), glucose or other sugars, one or more syrups, trisodium citrate, glycerin, maltodextrin, one or more vitamins, one or more minerals, one or more proteins, one or more osmotic agents, flavoring, other suitable ingredients, or combinations thereof.

In an embodiment, the forward osmosis membranes may include cellulose esters due to its low cost, durable surface, heat sealability, and hydration speed. These membranes are made wet and can shrink and crack if allowed to dry, so to preserve the membrane, the water hydrating the membrane is replaced with glycerin. If the membrane pouch is stored with solid osmotic agents or other contents, and in particular salts, in direct contact with the membrane, the osmotic agent can draw the glycerin from the membrane. This can impact the integrity of the forward osmosis membrane during the storage time between manufacturing and use of the product. Salts may act to dry out the membrane, allowing it to become brittle and crack. It is noted that at least some other forward osmosis membranes may shrink and/or crack if allowed to dry. Some conventional forward osmosis devices address the issue of shrinking and/or cracking of dried forward osmosis membranes by at least one of adding glycerin or water to the osmotic agent during packaging; having a paste made from water, sugar, glycerin, and maltodextrin as the osmotic agent; or having the user add the osmotic agent directly before use such as adding a syrup from a container to start the hydration or having a portion of the pouch made of a plastic film where the osmotic agent is folded into the plastic portion and kept from the membrane until use when it is unfolded.

The forward osmosis devices disclosed herein minimize shrinking and/or cracking of the forward osmosis membranes by including one or more barriers that prevent or at least inhibit contact between the forward osmosis membranes and one or more components of the forward osmosis devices (e.g., some osmotic agents) that would cause drying of or otherwise damage the forward osmosis membranes. Examples of the barriers disclosed herein include at least one of one or more capsules, one or more tablets, one or more dissolvable pouches, one or more dissolvable materials, or one or more tea bags that include components of the forward osmosis devices that would cause drying of or otherwise damage the forwards osmosis membranes.

In addition to protecting the membrane from the osmotic agents and other ingredients as needed, the barriers disclosed herein may protect the ingredients stored therein. For example, in a humid environment, a small amount of water from the air may condense and be transferred to the interior side of the forward osmosis device. The barriers disclosed herein may prevent such water from interacting with one or more of the osmotic agents or other ingredients disposed in the barrier.

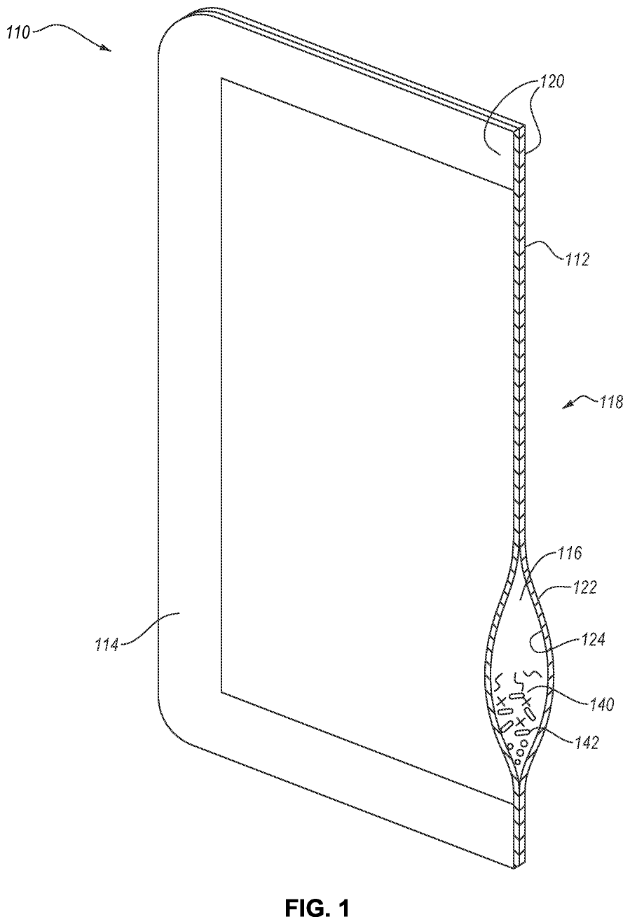

FIG. 1 isometric and cross-section view of a forward osmosis device 110 (e.g., a sealed forward osmosis pouch), according to an embodiment. The forward osmosis device 110 includes various ingredients 140 to make a drink. The forward osmosis device 100 includes one or more of the walls 120 (e.g., pouch walls) can be at least partially include one or more forward osmosis membranes 112. In an embodiment, the forward osmosis membranes 112 include cellulose triacetate on a supportive non-woven backing, such as is commercially available from Fluid Technology Solutions of Albany, Oreg. It is noted that the forward osmosis membranes 112 may include other forward osmosis membranes or filter materials that provide appropriate rejection levels of bacteria, viruses, and most solutes to provide a safe drink may be used. The walls 120 are sealed along the perimeter to form sealed area 114 and create the interior 116 (e.g., filtrate side) and exterior 118 (e.g., challenge liquid or retentate side) of forward osmosis device 110 and fully enclose the ingredients 140. In an embodiment, the forward osmosis membrane 112 includes a backing side 124 that faces (e.g., at least partially defines) the interior 116 or filtrate side of the pouch and the cellulose triacetate side 122 faces the exterior 118. Alternate constructions of the forward osmosis device 110, for example a pouch within a plastic bag where the challenge liquid goes inside the pouch and the filtrate of the challenge liquid collects between the plastic bag and the outside of the pouch, are possible. The forward osmosis device 110 is an example of a forward osmosis device that may include any of the barriers disclosed herein including combinations of two or more of any of the barriers disclosed herein. For example, the barriers of the forward osmosis device 110 may be disposed in the interior 116.

Among the ingredients 140 are at least one osmotic agent 142 which act to bring water from outside the pouch across the membrane 112 and to the inside of the pouch 110. At least a portion of the osmotic agent contacts the membrane.

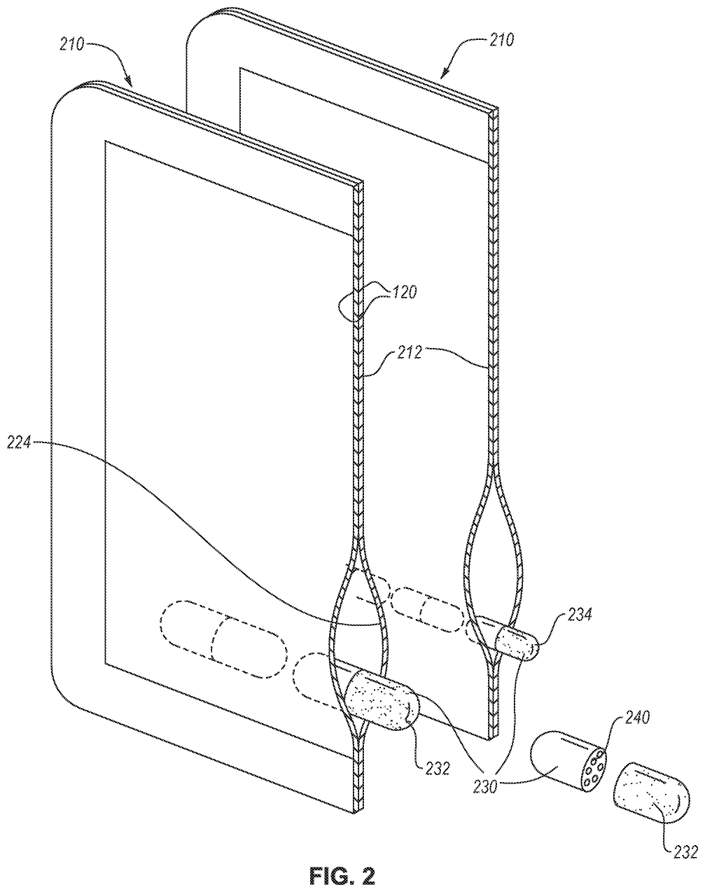

FIG. 2 is an isometric cutaway view of two forward osmosis devices 210, according to an embodiment. Except as otherwise disclosed herein, each of the forward osmosis devices 210 may be the same or substantially similar to any of the forward osmosis devices disclosed herein. The forward osmosis devices 210 may include one or more barriers. The barriers of the forward osmosis device 210 may include one or more capsules 230. At least the ingredients 240 (e.g., the osmotic agent and other ingredients) that can damage the forward osmosis membranes 212 are located inside one or more dissolvable food grade or pharmaceutical grade capsules. The capsules 230 are configured to dissolve in water. The capsules 230 may be put inside the forward osmosis device 210 and the capsules 230 provides a barrier so the contents inside the capsules 230 cannot contact the forward osmosis membranes 212. A secondary barrier (not shown) between the capsules 230 and the forward osmosis membranes 212 may be used as long as the secondary barrier does not prevent the capsules 230 from having access to the challenge liquid (e.g., water or other filtrate) coming through the forward osmosis membranes 212. The contents inside the capsules 230 can be separated by ingredients (ingredients include osmotic agents), some ingredients mixed together, or all ingredients mixed together.

The capsules 230 containing osmotic agent may have a short dissolving time so as to minimize the impact on hydration time for the forward osmosis devices 210. Different duration times may be desirable for other ingredients that are in other capsules 230.

In an embodiment, at least one of the capsules contains at least one osmotic agent. In an embodiment, all ingredients 240 in the forward osmosis devices 210 may be in the capsules 230. In an embodiment, not all ingredients 240 need to be in the capsule 230. Having some portion of osmotic agent that will not dry out the forward osmosis membranes 212 located inside the forward osmosis device 210. In other words, the forward osmosis devices 210 may include a portion of osmotic agent that does not present a risk to the integrity of the forward osmosis membranes 212. In an example, the ingredients outside of the capsules 230 may aid in getting the challenge liquid to the capsules 230 so the capsules 203 can be dissolved and release the osmotic agent inside thereby accelerating hydration of the forward osmosis devices 210. In such an example, having some osmotic agent outside the capsules may be necessary to draw at least an amount water into the pouch to dissolve enough of the capsule to gain access to the osmotic agent in the capsules 230. Examples of the osmotic agent that may be disposed outside of the capsules 230 includes glycerin added as part of the manufacturing process to keep the forward osmosis membranes 212 from drying out. Glycerin is an osmotic agent and draws water into the pouch to start the hydration process. With an adequate amount of glycerin on the backing side of the membrane 224, enough water can be drawn into the pouch to at least partially dissolve the capsule or capsules. The ingredients outside of the capsules 230 may include at least one ingredient that reacts undesirably with at least one other ingredient or at least one ingredient that is difficult to mix with at least one other ingredient.

The capsules 230 of the illustrated embodiment includes one or more larger capsules 232 and one or more smaller capsules 234 inside a forward osmosis pouch 210. In an embodiment, the larger capsules 232 may be disposed in one forward osmosis device 210 and the smaller capsules 234 may be disposed in another forward osmosis device 210. In an embodiment, at least one of the two forward osmosis devices 210 may include both the larger capsules 232 and the smaller capsules 234. In an embodiment, the larger capsules 232 may include ingredients 240 that are different or the same as the ingredients 240 of the smaller capsules 234.

Using the smaller capsules 234 (i.e., decreasing the size of the capsules 230) has the advantage of providing a slimmer profile for the forward osmosis device 210 compared to using larger capsules 232 for the same volume of material inside. The slimmer profile of the capsules 230 also results in less air trapped inside the forward osmosis devices 210 which is beneficial as air may reduce the amount of the forward osmosis membranes 212 exposed to the osmotic agents which in turn may increase the hydration time. Additionally, the smaller capsules 234 are less likely than larger capsules 232 to get damaged in the forward osmosis devices 212 during shipping and handling. In an example, the capsules 230 may exhibit a capsule size 000, size 00, size 0, size 1, size 2, size 3, size 4, size 5, or combinations thereof. In an example, the capsules 230 may exhibit a volume of about 0.1 ml to about 0.2 ml, about 0.15 ml to about 0.25, about 0.2 ml to about 0.3 ml, about 0.25 ml to about 0.35 ml, about 0.3 ml to about 0.4 ml, about 0.35 ml to about 0.5 ml, about 0.4 ml to about 0.6 ml, about 0.5 ml to about 0.7 ml, about 0.6 ml to about 0.8 ml, about 0.7 ml to about 0.9 ml, about 0.8 ml to about 1 ml, or about 0.9 ml to about 1.4 ml. In an example, the capsules 230 may include an external diameter of about 4.5 mm to about 5.5 mm, about 5 mm to about 6 mm, about 5.5 mm to about 6.5 mm, about 6 mm to about 7 mm, about 6.5 mm to about 7.5 mm, about 7 mm to about 8 mm, about 7.5 mm to about 8.5 mm, about 8 mm to about 9 mm, or about 8.5 mm to about 10 mm. In an example, the capsules 230 may exhibit a cut length of about 6 mm to about 8 mm, about 7 mm to about 9 mm, about 8 mm to about 10 mm, about 9 mm to about 11 mm, about 10 mm to about 12 mm, about 11 mm to about 13 mm, about 12 mm to about 14 mm, about 13 mm to about 15 mm, about 14 mm to about 17 mm, about 16 mm to about 19 mm, or about 18 mm to about 22 mm.

In an embodiment, the capsules 230 housing ingredients 240 are configured break open when pinched the walls 220 of the forward osmosis devices 210 to break open the capsules 230 just prior to hydration. This allows the contents of the capsules 230 to spill out of the capsules 230 and to contact the forward osmosis membranes 212. No dissolving of the capsules 230 is needed.

The capsules 230 may be formed from a variety of different material options which may be selected based on the specific application. The capsule material should not substantially negatively impact key properties of the final drink. Hard shelled capsules, such as those marketed by Capsugel, have two halves that come together to securely hold ingredients such as dry powders or pellets, although there are liquid filled hard capsules. Soft-gel capsules, such as those marketed by Capsugel, often contain liquids or contain ingredients suspended in a gel. Capsules 230 may be made of gelatin from animal sources such as fish, cows, and pigs. Vegetarian capsules are available and can be made from hydroxypropyl methylcellulose (HPMC) or starch which can be readily dissolved in water.

As an alternative to the capsule, the osmotic agent or agents as well as the other ingredients may be formed into a tablet or caplet. Additive(s) may be used to bind the ingredients together. The osmotic agent(s) may be buried internally within the tablet so as not to be available at the surface of the tablet. Otherwise, an external surface coating can be used to provide a barrier between the osmotic agent in the tablet and the membrane. When filtrate contacts the coating, the coating dissolves and the osmotic agent becomes exposed and available.

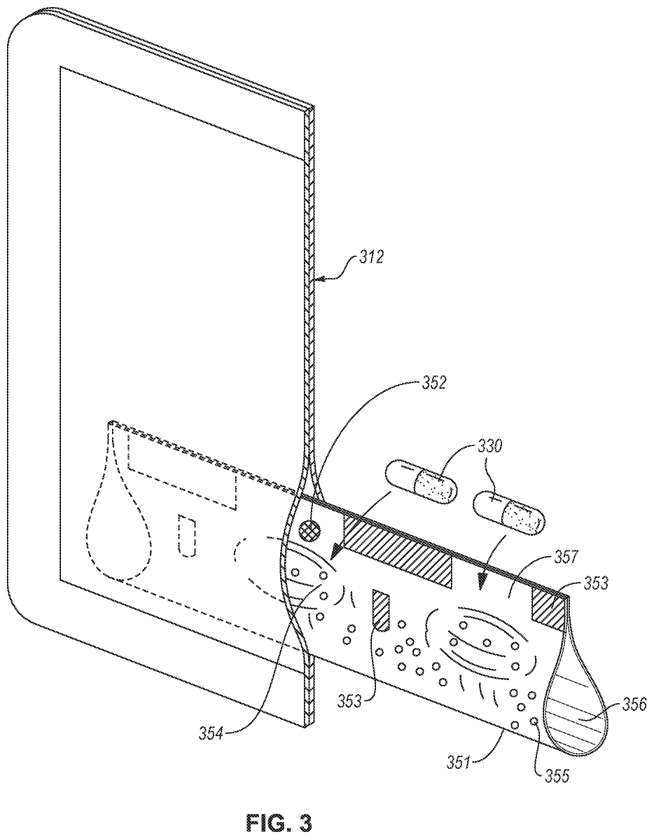

FIG. 3 is an isometric cutaway view of a forward osmosis device 310, according to an embodiment. Except as otherwise disclosed herein, the forward osmosis device 310 may be the same or substantially similar to any of the forward osmosis devices disclosed herein. The forward osmosis device 310 includes one or more barriers. The barriers may include a secondary barrier 350 and one or more additional barriers disposed in the secondary barrier 350. The additional barriers are discussed herein as being one or more capsules 330 though, it is noted, the additional barriers may include any of the other barriers disclosed herein in addition to or instead of the capsules 330.

The secondary barrier 350 is positioned between the capsules 330 and the one or more forward osmosis membranes 312 (e.g., the capsules 330 are disposed in the secondary barrier 350). The secondary barrier 350 physically separates the capsules 330 from the forward osmosis membrane 312. The secondary barrier 350 is of a shape and material softness to prevent damage the forward osmosis membranes 312. The secondary barrier 350 can aid in at least one of positioning the capsules 330, protecting the capsules 330 from damage during shipping and handling, preventing the capsules 330 from contacting the forward osmosis membranes 312 should there be any chance of physical damage or chemical damage to the forward osmosis membranes 312, keeping undissolved portions of the capsules 330 captured, or directing water flow inside the forward osmosis device 310. The secondary barrier 350 can be weighted to aid in keeping the secondary barrier 350 positioned at the low spot of the forward osmosis device 310 and in contact with the challenge liquid (e.g., water).

In an embodiment, the secondary barrier 350 includes a folded over piece of film 351 made of a material such as polyethylene that is heat staked 352 to the inside of the forward osmosis device 310 near the bottom seal. The film 351 is shown partially sealed at seal areas 353 keeping each of the capsules 330 in location. The capsules 330 can be spread out along the bottom of the secondary barrier 350 in case the challenge liquid collects on one side before the other. The film 351 can have recesses 354 formed therein to fit the capsules 330. Slits or holes 355 in the film 351 or open side channels 356 provide access for the challenge liquid to contact the capsules 330. Alternatively, the side channels 356 can be closed. The secondary barrier 350 may also or alternatively include one or more open areas 357 at the top that can encourage outward flow in that direction creating a mixing effect within the forward osmosis device 310 which can reduce hydration time. The capsules 330 can be positioned at different heights or have different dissolving times or have continuous release of osmotic materials over an extended time period.

The secondary barrier 350 can be in many different configurations and materials. For example, a mesh tube can house the capsules 330 with the tube twisted on each side of the capsules 330 to close off the tube to keep the capsules 330 in place.

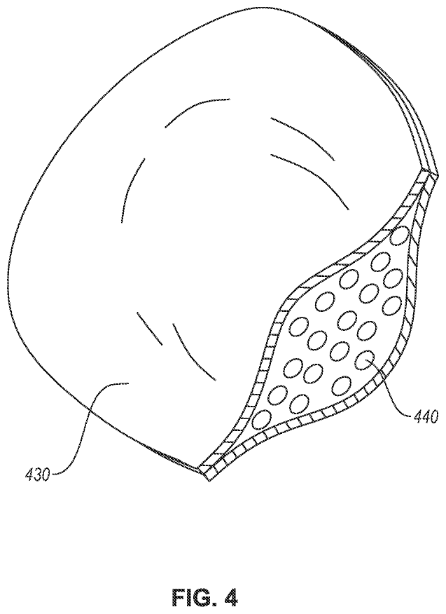

FIG. 4 is an isometric cutaway view of a dissolvable pouch 430 that may be at least a portion of the barriers used in any of the forward osmosis devices disclosed herein, according to an embodiment. The pouch 430 may include a dissolvable food grade or pharmaceutical grade edible pouch 430 located inside the forward osmosis device. In an embodiment, the pouch 430 may house at least some of the ingredients 440 (e.g., osmotic agent or other ingredients) of a forward osmosis device. For example, the pouch 430 may include the ingredients that can damage the forward osmosis membranes of a forward osmosis device. The pouches dissolve in water. The pouches are similar in use to the capsules but have the advantage of being flat thus providing for a slim profile, even in a single pouch. The slim profile of the pouch 430 may be advantageous in that they can be flat allowing for the forward osmosis device to have a flat profile. The pouch 430 can keep the same or similar thickness while length and width can be adjusted to accommodate different amounts of ingredients 440. In an embodiment, all of the pouch 430 is dissolvable. In an embodiment, only a portion of the pouch 430 is dissolvable or otherwise openable when contacted with challenge liquid (e.g., water or the solution) in the pouch 430 to provide access to the ingredients 440. The pouches 430 can be a mixture of the dissolvable material and any of the ingredients 440.

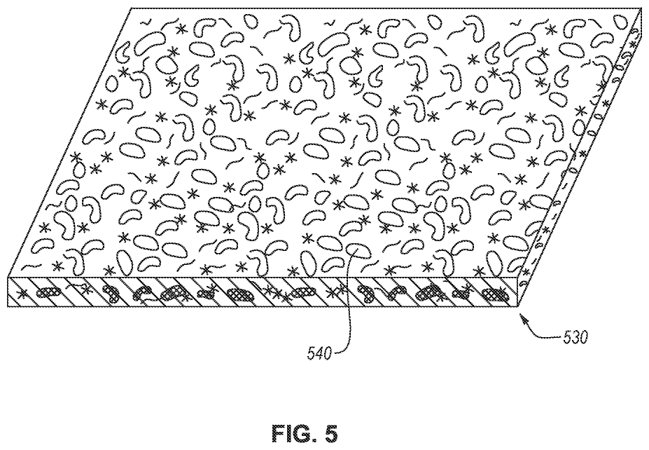

FIG. 5 is an isometric view of a dissolvable strip or sheet 530, according to an embodiment. The dissolvable strip or sheet 530 may be a barrier that is used in any of the forward osmosis devices disclosed herein. The dissolvable strip or sheet 530 includes one or more ingredients 540, such at least the osmotic agent or other ingredients that can potentially damage the forward osmosis membrane. The dissolvable strip or sheet 530 contents is a mixture of the dissolvable material, the osmotic agent, and any other selected ingredients mixed, blended, infused, melted, or otherwise put together. If the osmotic agent or other ingredient that can damage the forward osmosis membranes is still active at the surface of the strip or sheet, a dissolvable coating can be applied to the surface or the osmotic agent may be concentrated internally so there is very limited availability of such ingredients 540 at the outside surface of the dissolvable strip or sheet 530.

In an embodiment, any of the forward osmosis devices disclosed herein may include a plurality of dissolvable strips or sheets 530. In an embodiment, the dissolvable strips of sheets 530 may form an interior surface of the forward osmosis membranes. In an embodiment, the dissolvable strip or sheet 530 may be provided in a rolled form. In an embodiment, the blended material of dissolvable material and the osmotic agent and other ingredients can be shaped into forms other than the strip or sheet discussed above. For example, the blended material may be a flat mesh tube or v-shaped thin plastic trough configured to protect the forward osmosis membranes while still allowing the challenge liquid coming through the forward osmosis membranes to the blended material

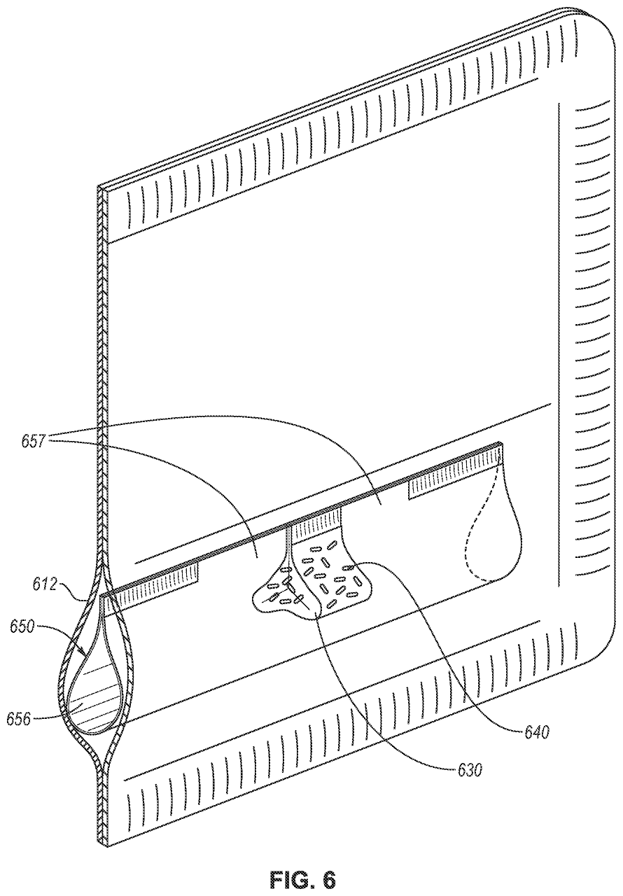

FIG. 6 is an isometric cross-sectional view of a forward osmosis device 610, according to an embodiment, with one of the walls illustrated as being transparent for illustrative purposes. Except as otherwise disclosed herein, the forward osmosis device 610 is the same or substantially similar to any of the forward osmosis devices disclosed herein. The forward osmosis device 610 includes one or more barriers. The barriers include at least one porous container 630 containing osmotic agent 642 and other ingredients as may be used for the specific application. The porous container houses and holds one or more ingredients 640, such as at least one osmotic agent, so that the ingredients 640 are not able to contact the one or more forward osmosis membranes 612 anytime before use. When the forward osmosis device 610 includes a plurality of ingredients 640, the different ingredients 640 may be put into the same or different porous container 630. During use, water from the challenge fluid is drawn across the membrane 612. The water, including other materials mixed with the water, flows through the porous container 630 and takes with it some of the osmotic agent from inside the porous container 630 as the water flows out through the porous container 630. The porous container 630 may include, for example, a tea bag construction.

In some embodiments, the porous material 630 may not provide adequate protection to prevent some salt or other potentially destructive ingredient from acting on the forward osmosis membranes 612, the forward osmosis device 610 may include a secondary barrier 650 between the porous container 630 and the forward osmosis membranes 612 to protect the forward osmosis membranes 612 from any potentially destructive ingredients 640 held inside the container. The secondary barrier 650 may be the same or substantially similar to the secondary barrier 350 except that the secondary barrier 650 may receive the porous material 630. The secondary barrier 650 can be a thin plastic film that wraps around the tea bag and is secured to the tea bag or around the tea bag. The sides are left open to allow water to flow around or through the tea bag. The secondary barrier 650 is secured to or around the porous container 630 in a manner that allows challenge liquid to readily access the porous container 630. The open sides 656 allow filtrate to flow around or through the porous container and out through the top opening 657. The secondary barrier 650 can be shaped and secured in a manner to encourage water flow in a specific direction or directions. The water flow can be directed to enhance convection of the challenge liquid within the forward osmosis barrier 610 which is favorable for hydration time. The secondary barrier 650 can be configured so that the density changes in the fluid caused by the dissolution of at least some of the ingredients 640 (e.g., a salt osmotic agent) induce natural convection cells which increase water transfer through the forward osmosis membranes 612.

The secondary barrier 650 exhibit other configurations and can be used in combination with the other components and approaches disclosed to hold the osmotic agent or other ingredient of interest and protect the forward osmosis membrane prior to use such as during shipping or storage.

This embodiment as well as other embodiments presented for forward osmosis hydration products can also be used for other clean water needs as well as for dewatering or concentration products in a variety of applications and industries.

While various aspects and exemplary embodiments have been disclosed herein, other aspects and embodiments will be apparent to those skilled in the art. The various aspects and exemplary embodiments disclosed herein are for the purposes of illustration and are not intended to be limiting.

What is claimed is:

1. A storage protection device for a forward osmosis hydration or dewatering system, the storage protection device comprising:
one or more forward osmosis membranes at least partially defining an interior; and
one or more barriers including one or more osmotic agents disposed therein, the one or more barriers disposed in the interior, the one or more barriers configured to:
prior to introducing a challenge liquid to the interior, separate the at least one osmotic agent and the one or more forward osmosis membranes;
after introducing the challenge liquid to the interior, allow the challenge liquid to access the at least one osmotic agent disposed in the chamber.

2. The storage protection device of claim 1, wherein the one or more forward osmosis membranes at least a portion form a pouch.

3. The storage protection device of claim 1, wherein the one or more barriers includes at least one capsule, the capsule at least partially dissolvable when contacted with the challenge liquid.

4. The storage protection device of claim 1, wherein one or more barriers includes a low profile dissolvable pouch which is at least partially dissolvable when contacted with the challenge liquid.

5. The storage protection device of claim 1, the one or more barriers includes a dissolvable material combined with at least the at least one osmotic agent, wherein the at least one osmotic agent have limited availability to escape from the dissolvable material until in contact with the challenge liquid.

6. The storage protection device of claim 1 wherein the one or more barriers include a at least one porous container including at least one draw material therein, the at least one porous container allows the challenge liquid to flow the at least one porous material;
wherein the at least one draw material is configured to form a solution with the challenge liquid.

7. The storage protection device of claim 1, wherein the one or more barriers includes at least one of at least one capsule, at least one disposable pouch, or at least one dissolvable material; and
further comprising a secondary barrier physically separating the one or more barriers from the one or more forward osmosis membranes.

8. An ingredient separation device within a forward osmosis system, the ingredient separation device comprising:
one or more forward osmosis membranes at least partially defining an interior, the interior configured to be in direct fluid contact with the one or more forward osmosis membranes during post manufacturing, transportation, and storage period, the interior containing two or more ingredients including at least one osmotic agent disposed therein; and
one or more barriers including some of the two or more ingredients therein, the one or more barriers configured to maintain the some of the two or more ingredients separate from a remainder of the two or more ingredients, the one or more barriers disposed in the interior.

9. The ingredient separation device of claim 8, wherein the one or more forward osmosis membranes at least a portion form a pouch.

10. The ingredient separation device of claim 8, wherein the one or more barriers includes at least one capsule, the at least one capsule at least partially dissolvable when contacted with the challenge liquid.

11. The ingredient separation device of claim 8, wherein one or more barriers includes a low profile dissolvable pouch which is at least partially dissolvable when contacted with the challenge liquid.

12. The ingredient separation device of claim 8, the one or more barriers includes a dissolvable material combined with at least the at least one osmotic agent, wherein the at least one osmotic agent have limited availability to escape from the dissolvable material until in contact with the challenge liquid.

13. The ingredient separation device of claim 8 , wherein the one or more barriers include a at least one porous container including at least one draw material therein, the at least one porous container allows the challenge liquid to flow the at least one porous material;
wherein the at least one draw material is configured to form a solution with the challenge liquid.

14. The ingredient separation device of claim 8, wherein the one or more barriers includes at least one of at least one capsule, at least one disposable pouch, or at least one dissolvable material; and
further comprising a secondary barrier physically separating the one or more barriers from the one or more forward osmosis membranes.

15. A liquid flow management device for a forward osmosis system, the liquid flow management device comprising:
at least one osmotic agent; and
one or more barriers including the at least one osmotic agent therein, the one or more barriers positioned in a structure that allows at least a portion of a challenge liquid to directly contact the one or more barriers causing at least a portion of the at least one osmotic agent to be released from the one or more barriers, said structure having openings configured to encourage the at least a portion of the challenge liquid to flow in a manner as to promote mixing of contents within the forward osmosis system.

16. The liquid flow management device of claim 15 wherein, the one or more forward osmosis membranes at least a portion form a pouch.

17. The liquid flow management device of claim 15 wherein, wherein the one or more barriers includes at least one capsule, the at least one capsule at least partially dissolvable when contacted with the challenge liquid.

18. The liquid flow management device of claim 15, wherein one or more barriers includes a low profile dissolvable pouch which is at least partially dissolvable when contacted with the challenge liquid.

19. The liquid flow management device of claim 15, wherein the component to hold the osmotic agent is a dissolvable material combined with the osmotic agent which is at least partially dissolved when contacted with filtrate from the challenge liquid and releases the osmotic agent within the dissolved portion.

20. The liquid flow management device of claim 15, wherein the component to hold the osmotic agent is a porous container which holds the osmotic agent and allows filtrate to flow into and out of the container through the porous material, said filtrate taking at least some of the osmotic agent held in the container into solution.
